(19) United States
(12) Patent Application Publication
(10) Pub. No.: US 2026/0103290 A1
(43) Pub. Date: Apr. 16, 2026

(54) HYDROGEN SUPPLY DEVICE COMPRISING ITEMS OF EQUIPMENT DISTRIBUTED IN CONTAINERS WHICH ARE CONNECTED BY AT LEAST ONE CONNECTING SECTION SO AS TO FORM A COMPACT ASSEMBLY

(71) Applicant: Airbus Operations SAS, TOULOUSE (FR)

(72) Inventor: Frédéric SICK, TOULOUSE (FR)

(21) Appl. No.: 19/351,946

(22) Filed: Oct. 7, 2025

(30) Foreign Application Priority Data
Oct. 14, 2024 (FR) 2411067

(51) Int. Cl. B64D 37/30; B64F 5/40; F17C 9/00

(52) U.S. Cl. CPC B64D 37/30; F17C 9/00; B64F 5/40; F17C 2201/0109; F17C 2221/012; F17C 2223/0161; F17C 2265/066; F17C 2270/0189

(57) ABSTRACT

A hydrogen supply device with a hydrogen tank and at least one hydrogen circuit. The circuit includes at least one first section which is positioned in a first container which is airtight and which includes at least one item of equipment of a first category, at least one second section which is positioned in a dismountable second container which is airtight and which includes at least one item of equipment of a second category, and at least one connecting section connecting the first and second sections. The connecting section is positioned below the first and second containers or positioned below the first container and between the second container and the hydrogen tank.

### CROSS-REFERENCES TO RELATED APPLICATIONS

This application claims the benefit of French Patent Application Number FR2411067 filed on Oct. 14, 2024, the entire disclosure of which is incorporated herein by way of reference.

### FIELD OF THE INVENTION

The present application relates to a hydrogen supply device comprising items of equipment distributed in containers which are connected by at least one connecting section so as to form a compact assembly and an aircraft comprising at least one such hydrogen supply device.

### BACKGROUND OF THE INVENTION

According to a first embodiment of the prior art which can be seen in FIG. 1, a hydrogen supply device of an aircraft comprises at least one hydrogen tank 10 and a plurality of hydrogen circuits 12.1 to 12.4, each having at least one upstream end 14.1 to 14.2 connected to the hydrogen tank 10 and at least one downstream end 16.1 to 16.4 connected, in particular, to at least one hydrogen engine or to at least one fuel cell.

The terms “upstream” and “downstream” refer to the direction of flow of the hydrogen in each of the hydrogen circuits, which flows from upstream to downstream.

Each hydrogen circuit 12.1 to 12.4 comprises conduits 18 and various items of equipment 20 such as pumps, sensors, valves or heat exchangers, for example, which are connected to one another via the conduits 18.

As illustrated in FIG. 1, the items of equipment 20 and the conduits 18 are positioned in a container 22 which is airtight and in which an inert gas is injected or a vacuum is created. This container 22 is connected to the hydrogen tank 10.

In order to carry out maintenance or repair operations on the items of equipment 20 positioned in the container 22, it is necessary to dismount the hydrogen tank 10 and the container 22, to remove them from the aircraft in order to be able to open the container 22 and access the items of equipment 20. Once the maintenance or repair operation has been carried out, the hydrogen tank 10 and the container 22 are remounted in the aircraft.

This first embodiment is unsatisfactory since it leads to significant down-times of the aircraft.

In order to remedy this drawback, the document EP 4382433 proposes a second embodiment which can be seen in FIG. 2. According to this second embodiment, a hydrogen supply device comprises a hydrogen tank 24 and a plurality of hydrogen circuits 26.1 to 26.4, each comprising a first upstream section 28, first items of equipment 30 not requiring maintenance being provided in the region thereof, a downstream section 32, second items of equipment 34 requiring maintenance being provided in the region thereof, a connecting section 36 without items of equipment interposed between the upstream and downstream sections 28, 32; a first connecting system 38 connecting the upstream 28 and connecting 36 sections and a second connecting system 40 connecting the downstream and connecting sections 32, 36. Each of the first and second connecting systems 38, 40 has first and second parts 38.1, 40.1/38.2, 40.2 which are configured to occupy a connected state in which the first and second parts are connected and ensure a fluidic continuity, and a disconnected state in which the first and second parts are spaced apart.

In addition, the hydrogen supply device comprises an upstream container 42 which is fixed and integral with the hydrogen tank 24 in which the upstream sections 28 of the different hydrogen circuits 26.1 to 26.4 are positioned, a detachable connecting container 44 in which the connecting sections 36 of the different hydrogen circuits 26.1 to 26.4 are positioned and at least one detachable downstream container 46 in which the downstream sections 32 of the hydrogen circuits 26.1 to 26.4 are positioned.

The upstream container 42 is substantially parallelepipedal and comprises an upper face 42.1, the first parts 38.1 of the first connecting systems 38 being positioned in the region thereof. The downstream container 46 is substantially parallelepipedal and comprises an upper face 46.1, the second parts 40.2 of the second connecting systems 40 being positioned in the region thereof. The connecting container 44 comprises a lower face which has a first zone 44.1, the second parts 38.2 of the first connecting systems 38 being positioned in the region thereof, and a second zone 44.2, the first parts 40.1 of the second connecting systems 40 being positioned in the region thereof.

The hydrogen supply device comprises a dismountable first connecting system for connecting the upstream container 42 and the connecting container 44 and a dismountable second connecting system for connecting the connecting container 44 and the downstream container 46.

During operation, when it is assembled, the connecting container 44 is positioned above the upstream container 42, the first zone 44.1 of its lower face being in contact with the upper face 42.1 of the upstream container 42 and the first and second parts 38.1, 38.2 of the first connecting systems 38 being in the connected state. When it is assembled, the downstream container 46 is positioned below the connecting container 44, its upper face 46.1 being in contact with the second zone 44.2 of the lower face of the connecting container 44 and the first and second parts 40.1, 40.2 of the second connecting systems 40 being in the connected state.

According to this second embodiment, only the downstream container 46, in which the second item of equipment 34 requiring a repair or maintenance operation is positioned, is dismounted and handled. Since its mass and its volume are reduced relative to those of a single container of the first embodiment, the dismounted assembly can be more easily dismounted and handled, which simplifies the repair and maintenance operations.

However, this second embodiment is not entirely satisfactory since the positioning of the downstream containers 46 which are suspended below the connecting container 44 and cantilevered relative to the upstream container 42, requires a strengthening of the dismountable connecting systems, which contributes to an increase in the mass of the hydrogen supply device.

### SUMMARY OF THE INVENTION

The present invention aims to remedy all or some of the drawbacks of the prior art.

To this end, the subject of the invention is a hydrogen supply device comprising a hydrogen tank and at least one hydrogen circuit connected to the hydrogen tank, which comprises:
at least one first section which is positioned in a first container which is airtight, comprising at least one item of equipment of a first category,
at least one second section which is positioned in a second container which is airtight, comprising at least one item of equipment of a second category,
at least one connecting section which extends between a first end which is connected to the first section by a first connecting system and a second end which is connected to the second section by a dismountable second connecting system.

According to the invention, the connecting section is positioned below the first and second containers or positioned below the first container and between the second container and the hydrogen tank.

This solution makes it possible to obtain a hydrogen supply device which is compact in a horizontal plane, which facilitates the positioning thereof. It also contributes to facilitating the dismounting and the handling of the second container when it has to be replaced or when one of its components has to be repaired.

According to a further feature, the connecting section comprises at least one rigid connection manifold ensuring a fluidic continuity between the first section and the second section, said connection manifold being configured to be connected to an aircraft structure and/or the hydrogen tank.

According to a further feature, the hydrogen supply device comprises at least one connecting container in which the connecting section comprising a first substantially (+/−10%) horizontal wall is positioned, the first container being positioned above the first wall and comprising a lower wall in contact with the first wall or slightly spaced apart therefrom.

According to a further feature, the first container is cylindrical and has a substantially vertical axis of revolution.

According to a further feature, the first section comprises a rigid first manifold, which is positioned in the first container, to which a plurality of items of equipment of the first category are connected.

According to a further feature, the first manifold extends in a direction parallel to the axis of revolution.

According to a further feature, the first connecting system is permanent.

According to a further feature, the first connecting system is dismountable.

According to a further feature, the hydrogen supply device comprises at least one connecting system which connects, on the one hand, the first container and, on the other hand, the connecting section, a connecting container in which the connecting section is positioned and a connection manifold which is encompassed in the first section and/or the hydrogen tank.

According to a further feature, the connecting system comprises a plurality of rods or connecting links which each have a first end which is connected to the hydrogen tank and a second end which is connected to the first container.

According to a further feature, the second container is cylindrical and has a substantially horizontal axis of revolution.

According to a further feature, the second section comprises at least one rigid second manifold, which is positioned in the second container, to which a plurality of items of equipment of the second category are connected.

According to a further feature, the second manifold extends in a direction parallel to the axis of revolution.

According to a further feature, the second container comprises at least one support to which at least one of the items of equipment of the second category, at least one conduit connecting the items of equipment of the second category and/or at least one second manifold are fixed.

According to a further feature, the hydrogen supply device comprises at least one dismountable connecting system which is configured to connect, on the one hand, the second container and, on the other hand, the connecting section and a connecting container in which the connecting section and/or an aircraft structure is positioned.

A further subject of the invention is an aircraft comprising at least one hydrogen supply device according to one of the preceding features.

### BRIEF DESCRIPTION OF THE DRAWINGS

Further features and advantages will be found in the following description of the invention, the description being provided solely by way of example and with reference to the accompanying drawings, in which:

FIG. 1 is a schematic view of a hydrogen supply device illustrating a first embodiment of the prior art,

FIG. 2 is a schematic view of a hydrogen supply device illustrating a second embodiment of the prior art,

FIG. 3 is a schematic view of a hydrogen supply device illustrating an embodiment of the invention,

FIG. 4 is a lateral view of a hydrogen supply device illustrating an embodiment of the invention,

FIG. 5 is a perspective view of a hydrogen supply device illustrating an embodiment of the invention,

FIG. 6 is a perspective view of a part of the hydrogen supply device which can be seen in FIG. 5,

FIG. 7 is a perspective view of the elements present in a detachable container illustrating an embodiment of the invention,

FIG. 8 is a lateral view of a hydrogen supply device illustrating a further embodiment of the invention,

FIG. 9 is a view from above of a part of the hydrogen supply device which can be seen in FIG. 8.

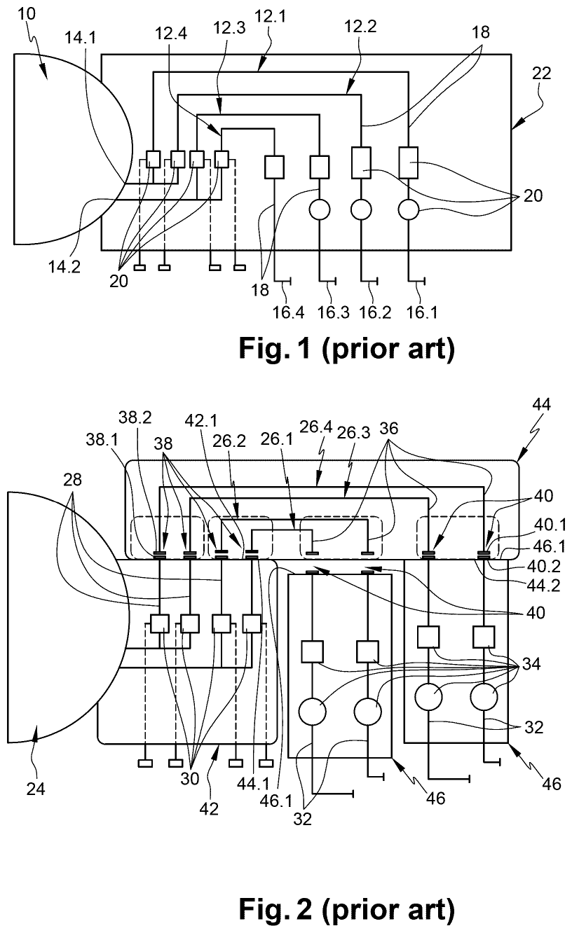

### DETAILED DESCRIPTION OF THE PREFERRED EMBODIMENTS

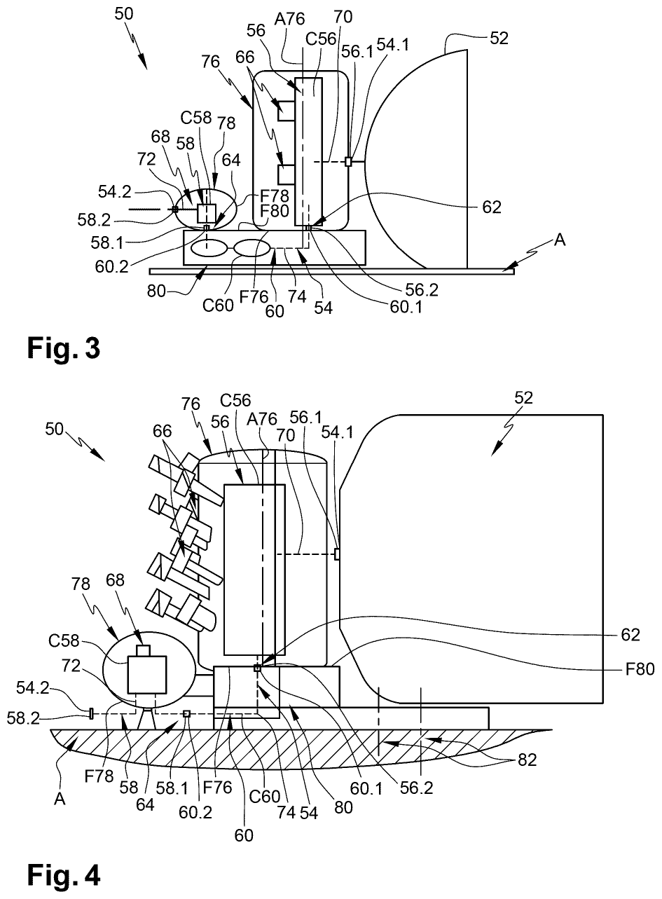

According to an embodiment which can be seen in FIG. 3, a hydrogen supply device 50 comprises at least one hydrogen tank 52 and at least one hydrogen circuit 54 which extends between an upstream end 54.1 which is connected to the hydrogen tank 52 to a downstream end 54.2 which is connected to an element (not shown) such as a hydrogen engine, a fuel cell, or the like. According to one configuration, the hydrogen tank 52 is configured to store hydrogen in the cryogenic state. At least one part of the hydrogen circuit 54 is configured to channel hydrogen in the cryogenic state.

According to one application, an aircraft comprises at least one hydrogen supply device 50. According to this application, the aircraft comprises an aircraft structure A to which the hydrogen tank 52 is rigidly connected.

The hydrogen supply device 50 can comprise a plurality of hydrogen circuits. For the purposes of clarity, only one hydrogen circuit 54 is shown in FIGS. 3, 4, 8 and 9.

The hydrogen circuit 54 comprises a first section 56 which extends between the first and second ends 56.1, 56.2, a second section 58 which extends between the first and second ends 58.1, 58.2 and at least one connecting section 60 which extends between the first and second ends 60.1, 60.2.

According to one embodiment which can be seen in FIG. 3, the first end 56.1 of the first section 56 corresponds to the upstream end 54.1 of the hydrogen circuit 54 and the second end 58.2 of the second section 58 corresponds to the downstream end 54.2 of the hydrogen circuit 54. This hydrogen circuit comprises a single connecting section 60, a first connecting system 62 dismountably connecting the second end 56.1 of the first section 56 and the first end 60.1 of the connecting section 60, and a second connecting system 64 dismountably connecting the second end 60.2 of the connecting section 60 and the first end 58.1 of the second section 58.

Naturally the invention is not limited to this embodiment. According to a further embodiment which can be seen in FIG. 8, the hydrogen supply device 50 comprises a first connecting section 60 connecting the first and second sections 56, 58, a second connecting section 60′ connecting the upstream end 54.1 of the hydrogen circuit 54 and the first section 56 and a third connecting section 60″ connecting the second section 58 and the downstream end 54.2 of the hydrogen circuit 54, the different sections 56, 58, 60, 60′, 60″ being dismountably connected to one another by connecting systems which are each configured to occupy a connected state in which the connecting system ensures a fluidic continuity between the two connected sections and a disconnected state in which the connecting system enables the two sections to be separated.

These connecting systems are not described in more detail since they may be identical to those of the prior art.

Whatever the embodiment, the hydrogen circuit extends from an upstream end 54.1 which is connected to the hydrogen tank 52 and comprises at least one first section 56, at least one second section 58, at least one connecting section 60 and at least one dismountable connecting system 64 connecting the connecting section 60 and the second section 58. According to one configuration, the first section 56 and the connecting section 60 are permanently connected to one another. According to this configuration, the first connecting system 62 is permanent and obtained by welding the first section 56 and the connecting section 60. According to a further configuration, the first section 56 and the connecting section 60 are also connected by a dismountable connecting system 62.

The hydrogen circuit 54 comprises at least one item of equipment of a first category 66 incorporated in the first section 56 and at least one item of equipment of a second category 68 incorporated in the second section 58. According to one configuration, the hydrogen circuit 54 can comprise a plurality of items of equipment of the first category 66, all incorporated in the first section(s) 56 and/or plurality of items of equipment of the second category 68, all incorporated in the second section(s) 58. Thus a first section 56 extends between at least one first end 56.1 and at least one second end 56.2 and comprises at least one item of equipment of a first category 66 and first conduits 70 for channeling hydrogen from the first end 56.1 to the second end 56.2. A second section 58 extends between at least one first end 58.1 and at least one second end 58.2 and comprises at least one item of equipment of a second category 68 and second conduits 72 for channeling the hydrogen from the first end 58.1 to the second end 58.2. Generally a connecting section 60 does not comprise any item of equipment and only comprises connecting conduits 74.

The items of equipment of the first category 66 do not require maintenance and are configured to have a service life which is greater than or equal to that of an aircraft. By way of example, the items of equipment of the first category 66 can be valves or indirect measuring sensors.

The items of equipment of the second category 68 require maintenance and are capable of being repaired. By way of example, the items of equipment of the second category 68 can be heat exchangers, evaporators or direct measuring sensors.

The hydrogen supply device 50 comprises at least one first container 76 in which at least one first section 56 is positioned and at least one second container 78 in which at least one second section 58 is positioned. The hydrogen supply device 50 can comprise at least one connecting container 80 in which at least one connecting section 60 is positioned.

The different containers 76, 78, 80 are containers which are airtight, an inert gas being injected or a vacuum being created in each thereof. The inert gas is, for example, helium. The vacuum corresponds, for example, to a pressure level in the container 76, 78, 80 which is lower than a predetermined pressure threshold, for example selected in the interval [1×10−6 mbar; 50 mbar] depending on the required level.

According to one configuration, the hydrogen supply device 50 comprises a single first container 76 in which a plurality of first sections 56 of different hydrogen circuits 54 are positioned. As a variant, the hydrogen supply device 50 could comprise a plurality of first containers 76, the first section 56 of at least one hydrogen circuit 54 being positioned in each thereof.

The hydrogen supply device 50 comprises a single second container 78 in which a plurality of second sections 58 of different hydrogen circuits 54 are positioned. As a variant, the hydrogen supply device 50 comprises a plurality of second containers 78, the second section 58 of at least one hydrogen circuit 54 being positioned in each thereof.

According to one embodiment, the hydrogen supply device 50 comprises a single connecting container 80 in which a plurality of connecting sections 60 of different hydrogen circuits 54 are positioned. As a variant, the hydrogen supply device 50 could comprise a plurality of connecting containers 80, the connecting section 60 of at least one hydrogen circuit 54 being positioned in each thereof.

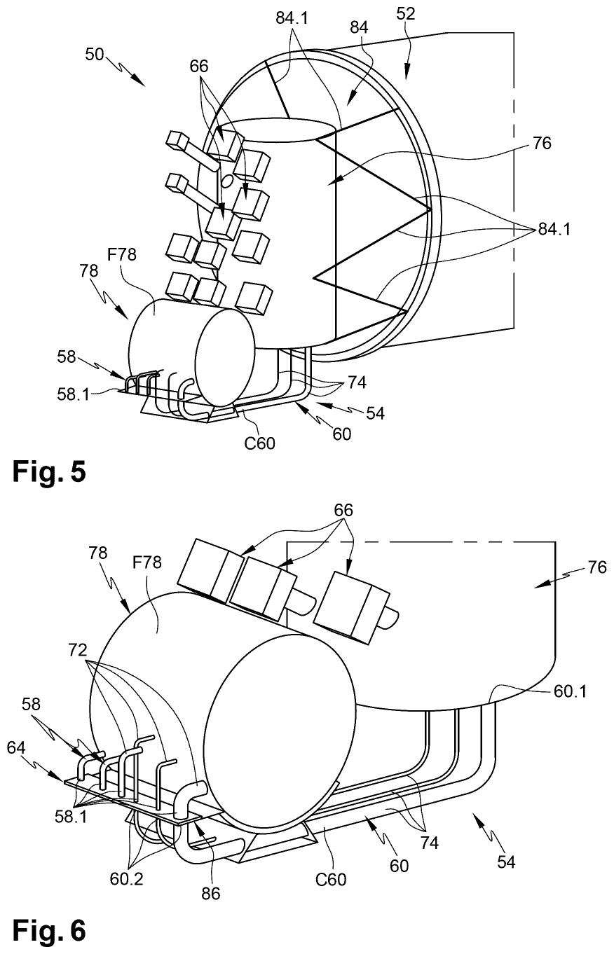

As illustrated in FIGS. 5 and 8, at least one item of equipment of the first category 66 can be positioned partially inside the first container 76 and partially outside the first container 76. By way of example, an item of equipment of the first category 66 can be an encapsulated valve in a position straddling the inside and the outside of the first container 76.

According to an advantageous configuration, the first container 76 is cylindrical and has a substantially vertical axis of revolution A76. The first container comprises a lower wall F76 substantially perpendicular to the axis of revolution A76 and a lateral wall which is cylindrical and coaxial with the axis of revolution. The lower wall F76 can have a dome shape. The first container 76 is positioned in the vicinity of the hydrogen tank 52. At the same time, each second container 78 is cylindrical and has a substantially horizontal axis of revolution A78. The second container comprises a lateral wall F78 which is cylindrical and coaxial to the axis of revolution A78. These shapes and orientations of the first and second containers 76, 78 contribute to improving the compactness of the hydrogen supply device 50.

According to an arrangement which can be seen in FIG. 9, the hydrogen tank 52, the first container 76 and the second container 78 are aligned in a direction of alignment D and slightly spaced apart from one another. This arrangement contributes to obtaining a compact hydrogen supply device 50. The invention is not limited to this arrangement.

According to one embodiment, the connecting container 80 has a substantially parallelepipedal shape and a substantially horizontal upper first wall F80.

The propulsion unit comprises at least one first connecting system 82 connecting the connecting container 80 and the aircraft structure A and/or the hydrogen tank 52.

According to a particularity of the invention, the connecting section 60 (more particularly the connecting container 80) is positioned at least partially below the first container 76. This arrangement contributes to obtaining a compact hydrogen supply device in the direction of alignment D. Thus the first container 76 is positioned above the first wall F80, the lower wall F76 of the first container 76 being in contact with the first wall F80 of the connecting container 80 or slightly spaced apart therefrom. According to this arrangement, the first connecting system 62 comprises first and second parts respectively positioned in the region of the lower wall of the first container 76 and the first wall F80 of the connecting container 80.

According to a further arrangement, the lower wall F76 of the first container 76 and the first wall F80 of the connecting container 80 are slightly spaced apart. In this case, the first connecting system 62 can be positioned in the region of the lower wall F76 of the first container 76, in the region of the first wall F80 of the connecting container 80 or between the lower wall F80 of the first container 76 and the first wall F80 of the connecting container 80.

In addition, the hydrogen supply device 50 comprises at least one second connecting system 84 which connects, on the one hand, the first container 76 and, on the other hand, the connecting section 60, a connecting container 80 in which the connecting section 60 is positioned and/or the hydrogen tank 52. According to an embodiment which can be seen in FIGS. 5 and 8, the second connecting system 84 comprises a plurality of rods or connecting links 84.1 which each have a first end connected to the hydrogen tank 52 and a second end connected to the first container 76. Naturally the invention is not limited to this embodiment for the second connecting system 84. Thus the second connecting system 84 could be dismountable. In the case of the present invention, it is understood that a connecting system is dismountable if the two elements connected by the connecting system can be disconnected and connected virtually indefinitely, the operation for disconnecting or connecting the elements being implemented rapidly with a smaller number of tools.

According to a first arrangement which can be seen in FIG. 3, the connecting section 60 (more particularly the connecting container 80) is positioned at least partially below the second container 78. Thus the lateral wall F78 of the second container 78 is in contact with the first wall F80 of the connecting container 80, or slightly spaced apart therefrom. According to this first arrangement, the second connecting system 64 comprises first and second parts respectively positioned in the region of the first wall F80 of the connecting container 80 and the lateral wall F78 of the second container 78.

According to a further arrangement which can be seen in FIG. 4, the connecting section 60 (more particularly the connecting container 80) is offset in the direction D relative to the second container 78 and positioned between this second container and the hydrogen tank 52. According to this arrangement, the lateral wall F78 of the second container 78 is not positioned above the first wall F80 of the connecting container 80. The dismountable second connecting system 64 is located in the region of the first wall F80 of the connecting container 80, in the region of the lateral wall F78 of the second container 78 or between the first wall F80 of the connecting container 80 and the lateral wall F78 of the second container 78, in particular in the region of a plate 86 integral with the second container 78 or the connecting container 80.

According to a further arrangement which can be seen in FIG. 8, the connecting container 80 comprises a second wall F80′ which is substantially horizontal and offset vertically relative to the first wall F80. According to this arrangement, the second container 78 is positioned on the connecting container 80, more particularly on the second wall F80′ of the connecting container 80. Thus the lateral wall F78 of the second container 78 is in contact with the second wall F80′ of the connecting container 80 or slightly spaced apart therefrom. The second connecting system 64 comprises first and second parts respectively positioned in the region of the lateral wall F78 of the second container 78 and the second wall F80′ of the connecting container 80.

According to a further arrangement, the lateral wall F78 of the second container 78 and the second wall F80′ of the connecting container 80 are slightly spaced apart. In this case, the second connecting system 64 can be positioned in the region of the lateral wall F78 of the second container 78, in the region of the second wall F80′ of the connecting container 80 or between the lateral wall F78 of the second container 78 and the second wall F80′ of the connecting container 80.

The connecting container 80 can contain connecting pipes of the single-walled type and/or connecting pipes of the double-walled or triple-walled type as a function of the type of the items of equipment contained in the second container 78. For example, when the container 78 contains a heat exchanger with a downstream gaseous distribution of hydrogen, pipes of the single-walled type make it possible to start to heat up the liquid hydrogen before the introduction thereof into the heat exchanger. For example, when the second container 78 contains a pump provided for a distribution of hydrogen in liquid form, pipes of the double-walled or triple-walled type permit an improved thermal insulation of the liquid hydrogen.

In addition, the hydrogen supply device comprises at least one third connecting system 88 connecting, on the one hand, the second container 78 and, on the other hand, the connecting section 60 and a connecting container 80 in which the connecting section 60 and/or the aircraft structure A are positioned. This third connecting system 88 is dismountable in order to be able to dismount the second container 78. According to one embodiment which can be seen in FIG. 8, the third connecting system 88 comprises a plurality of rods or connecting links which have a first end connected to the second container 78 and a second end connected to the connecting container 80, at least one of the first and second ends being dismountably connected. Naturally the invention is not limited to this embodiment for the third connecting system 88. Whatever the embodiment, the second container 78 is dismountable, which contributes to simplifying the maintenance and repair operations of the items of equipment of the second category 68. This second container 78 is positioned on the connecting container 80 or slightly offset relative thereto. This arrangement improves the accessibility of the second container 78 which contributes to facilitating the dismounting operations of the second container 78. Since the first container 76 is positioned above the connecting container 80, the positioning of the second container 78 on the connecting container 80, or slightly offset relative thereto, contributes to improving the compactness of the hydrogen supply device and reduces its bulk in a horizontal plane. This also makes it possible to reduce the length of the connecting section(s) 60.

According to one embodiment, the connecting section 60 comprises at least one connection manifold C60 ensuring a fluidic continuity between one or more first section(s) 56 (or one or more first container(s) 76) and one or more second section(s) 58 (or one or more second container(s) 78). This connection manifold C60 can comprise at least one standby inlet and/or at least one standby outlet in order to be able to connect a new item of equipment, or a first or second section 56, 58 of a first or second additional container 76, 78.

According to one arrangement, this connection manifold C60 is rigid and configured to be connected, as a result of the first connecting system 82, to the aircraft structure A and/or to the hydrogen tank 52.

According to one embodiment, the connection manifold C60 is configured to channel hydrogen in the cryogenic state with a high level of safety in terms of leakage. By way of example, the connection manifold C60 comprises a double casing. In this case, the connecting container 80 is not required. Each first container 76 can be connected by the second connecting system 84 to the connection manifold C60. In this case, the first container 76 is connected to the aircraft structure A and/or the hydrogen tank 52 by means of the connection manifold C60. At the same time, each second container 78 can be connected by the third connecting system 88 to the connection manifold C60. In this case, the second container 78 is connected to the aircraft structure A and/or the hydrogen tank 52 by means of the connection manifold C60. This connection manifold C60 can be obtained by molding or by a 3D printing technique.

The connection manifold C60 can be connected to at least one first section 56 by a permanent connection of the welded type, in order to limit the risks of leakage. As a variant, the connection manifold can be connected to at least one first section 56 by a connecting system which is configured to occupy alternately the connected and disconnected states.

According to one embodiment, for at least one first container 76, the first section 56 comprises at least one first rigid manifold C56, positioned in the first container 76, to which a plurality of items of equipment of the first category 66 are connected. According to one configuration, this first manifold C56 extends in a direction which is substantially vertical and parallel to the axis of revolution A76. This first manifold C56 makes it possible to replace a plurality of first conduits 70 which contributes to improving the compactness of the first section 56 and of the first container 76. According to one configuration, the first manifold C56 connects all of the encapsulated valves present in the first container 76.

This first manifold C56 can be obtained by molding or by a 3D printing technique. According to a first alternative, the first manifold C56 is formed as a single element. According to a second alternative, the first manifold C56 is formed from a plurality of elements so as to facilitate the manufacture and/or the maintenance thereof.

According to one embodiment, for at least one second container 78, the second section 58 comprises at least one second rigid manifold C58, positioned in the second container 78, to which a plurality of items of equipment of the second category 68 are connected. According to one configuration, this second manifold C58 extends in a direction which is substantially horizontal and parallel to the axis of revolution A78. This second manifold C58 makes it possible to replace a plurality of second conduits 72, which contributes to improving the compactness of the second section 58 and of the second container 78.

This second manifold C58 can be obtained by molding or by a 3D printing technique.

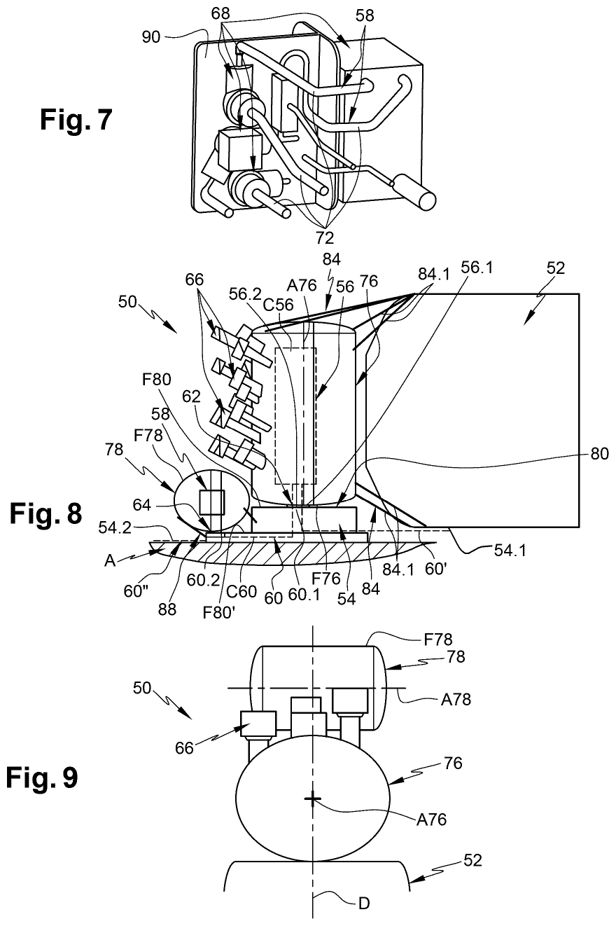

According to one embodiment which can be seen in FIG. 7, the second container 78 comprises at least one support 90 which is positioned in the second container 78, to which at least one of the items of equipment of the second category 68, at least one second conduit 72 connecting the items of equipment of the second category 68 and/or at least one second manifold C58 are fixed. Preferably, the items of equipment are integrated compactly in the second container 78, which makes it possible to reduce the volume of the second container 78 in order to facilitate the handling thereof during maintenance operations.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A hydrogen supply device comprising:
a hydrogen tank; and
at least one hydrogen circuit connected to the hydrogen tank, the least one hydrogen circuit comprising:
at least one first section positioned in a first container which is airtight, the at least one first section comprising at least one item of equipment of a first category,
at least one second section which is positioned in a second container which is airtight, the at least one second section comprising at least one item of equipment of a second category, and,
at least one connecting section which extends between a first end which is connected to the at least one first section by a first connecting system and a second end which is connected to the at last one second section by a dismountable second connecting system;
wherein the at least one connecting section is positioned below the first container and below the second container or positioned below the first container and between the second container and the hydrogen tank.

2. The hydrogen supply device as claimed in claim 1, wherein the at least one connecting section comprises at least one rigid connection manifold providing a fluidic continuity between the at least one first section and the at least one second section, said at least one rigid connection manifold configured to be connected to an aircraft structure, or to the hydrogen tank, or to both.

3. The hydrogen supply device as claimed in claim 1, further comprising:
at least one connecting container in which the at least one connecting section is positioned,
wherein the at least one connecting section comprises a first substantially horizontal wall, and
wherein the first container is positioned above the first substantially horizontal wall and comprises a lower wall in contact with the first substantially horizontal wall or spaced apart therefrom.

4. The hydrogen supply device as claimed in claim 1, wherein the first container is cylindrical and has a substantially vertical axis of revolution.

5. The hydrogen supply device as claimed in claim 1, wherein the at least one first section comprises a rigid first manifold,
wherein the rigid first manifold is positioned in the first container, and
wherein a plurality of items of equipment of the first category are connected to the rigid first manifold.

6. The hydrogen supply device as claimed in claim 5, wherein the first container is cylindrical and has a substantially vertical axis of revolution, and
wherein the first manifold extends in a direction parallel to the substantially vertical axis of revolution.

7. The hydrogen supply device as claimed in claim 1, wherein the at least one connecting section is permanent.

8. The hydrogen supply device as claimed in claim 1, wherein the at least one connecting section is dismountable.

9. The hydrogen supply device as claimed in claim 1, further comprising:
at least one connecting system connecting the first container and the at least one connecting section;
a connecting container in which the at least one connecting section is positioned; and
a connection manifold encompassed in the at least one first section, the hydrogen tank, or both.

10. The hydrogen supply device as claimed in claim 9, wherein the at least one connecting system comprises a plurality of rods or connecting links which each have a first end which is connected to the hydrogen tank and a second end which is connected to the first container.

11. The hydrogen supply device as claimed in claim 1, wherein the second container is cylindrical and has a substantially horizontal axis of revolution.

12. The hydrogen supply device as claimed in claim 1, wherein the at least one second section comprises at least one rigid second manifold positioned in the second container,
wherein a plurality of items of equipment of the second category are connected to the at least one rigid second manifold.

13. The hydrogen supply device as claimed in claim 12, wherein the second container is cylindrical and has a substantially horizontal axis of revolution, and,
wherein the second manifold extends in a direction parallel to the substantially horizontal axis of revolution.

14. The hydrogen supply device as claimed in claim 1, wherein the second container comprises at least one support to which the at least one item of equipment of a second category is fixed, or, at least one conduit connecting the at least one item of equipment of a second category is fixed, or at least one second manifold is fixed, or any combination of the foregoing.

15. The hydrogen supply device as claimed in claim 1, further comprising:
at least one dismountable connecting system connecting the second container and the at least one connecting section; and
a connecting container in which the at least one connecting section, or an aircraft structure, or both are positioned.

16. An aircraft comprising:
at least one hydrogen supply device as claimed in claim 1.
